(19) United States
(12) Patent Application Publication
(10) Pub. No.: US 2007/0252502 A1
(43) Pub. Date: Nov. 1, 2007

(54) Spark plug for improving the mixing degree between air and fuel

(76) Inventor: Ya Li Wang, Shin-Tien City (TW)

Correspondence Address: BACON & THOMAS, PLLC, 625 SLATERS LANE, FOURTH FLOOR, ALEXANDRIA, VA, 22314, US

(21) Appl. No.: 11/519,897

(22) Filed: Sep. 13, 2006

(30) Foreign Application Priority Data
Apr. 29, 2006 (CN) 200620041490.0

(51) Int. Cl. H01T 13/20

(52) U.S. Cl. 313/141

(57) ABSTRACT

A spark plug of an internal combustion engine is provided for improving the mixing degree between air and fuel, improving the combustion efficiency, eliminating carbon deposit, and decreasing exhaust emission. The spark plug comprises an isolator body, a metal casing, a central electrode and a ground electrode. The ground electrode is of three 180° spiral shape, two 180° spiral shape or one 180° spiral shape. The ends of the ground electrode straddle the central electrode and are connected to the metal casing.

### FIELD OF THE INVENTION

The present invention relates to a spark plug for an internal combustion engine, and more particularly to a spark plug for improving the mixing degree between air and fuel, improving combustion efficiency, eliminating carbon deposit, and decreasing exhaust emission.

### BACKGROUND OF THE INVENTION

A spark plug used in an internal combustion engine generally comprises an isolator body, a metal casing, a central electrode, and a ground electrode. With the development of science and technology and with the enhancement of environment protection, more and more motor vehicle manufactures would like to use the advanced multi-valve four-stroke internal combustion engine.

As shown in FIG. 1, which is a structural view of a conventional four-stroke engine, showing the relation between the ignition of the spark plug in the combustion chamber and an incomplete combustion. The combustion chamber is ignited in this way: fresh air enters into the intake manifold 20 and is mixed with the fuel sprayed out from the fuel injector 21. The mixture of fuel and air then enters into the combustion chamber 24 via the intake valve 23 for compression and is ignited by the spark plug 25 for explosion, and finally the exhaust gas is discharged via the exhaust valve 26. The disadvantage of this conventional spark plug is that the fresh air cannot be mixed uniformly with the fuel in the combustion chamber 24 and affects the combustion efficiency. The existing spark plug 25 is indispensably provided with a ground electrode 27 that is a main obstacle to flame propagation in the occurrence of a firing. The existence of the ground electrode 27 will cause a time difference of combustion when the mixed air and fuel are ignited in the combustion chamber 24, and this is a big disadvantage of the ground electrode 27. Furthermore, in the process of ignition, combustion and explosion will occur between the central electrode 12 and the ground electrode 27, and the ground electrode 27 will block the combustion, resulting in the time difference of combustion and the incomplete combustion. And even worse, carbon will be deposited in a cylinder, increasing the fuel consumption, causing air pollution and power reduction. Therefore, the mixing degree of fuel and air in the cylinder, the flame propagating velocity and direction, both have great influence on the combustion efficiency.

The present invention has arisen to mitigate and/or obviate the afore-described disadvantages.

### SUMMARY OF THE INVENTION

The primary objective of the present invention is to provide a spark plug for improving the mixing degree between fuel and air, increasing the flame propagating velocity in combustion and modifying the flame propagating direction. The spark plug is provided with ground electrode of 180° spiral shape, wherein the fresh air and the fuel can be directly sprayed onto the ground electrodes via the intake valve to form an eddy status, and thus the fuel and the air can be mixed more uniformly in the combustion chamber.

The first embodiment is that the spark plug comprises an isolator body, a metal casing, a central electrode and a ground electrodes of three 180° spiral shape, both ends of the ground electrode straddle the central electrode and are connected to the metal casing. There are three spark gaps in the spark plug, a first spark gap is formed between the central electrode and a left spiral of the ground electrode; a second spark gap is formed between the central electrode and a right spiral of the ground electrode; a third spark gap is formed between the central electrode and a central spiral of the ground electrode opposite to the central electrode.

The second embodiment is that the spark plug comprises an isolator body, a metal casing, a central electrode and a ground electrodes of two 180° spiral shape, both ends of the ground electrode straddle the central electrode and are connected to the metal casing. There are three spark gaps in the spark plug, a first spark gap is formed between the central electrode and a left spiral of the ground electrode, a second spark gap is formed between the central electrode and a right spiral of the ground electrode, a third spark gap is formed between the central electrode and a precious metal protrusion on the ground electrode opposite to the central electrode.

The third embodiment is that the spark plug comprises an isolator body, a metal casing, a central electrode and a ground electrodes of one 180° spiral shape, one end of the ground electrode is connected to the metal casing, and the other end of the ground electrode is formed with a precious metal protrusion opposite to the central electrode. There are two spark gaps in the spark plug, a first spark gap is formed between the central electrode and a right spiral of the ground electrode, a second spark gap is formed between the central electrode and the precious metal protrusion.

### BRIEF DESCRIPTION OF THE DRAWINGS

FIG. 1 is a structural view of a conventional four-stroke engine;

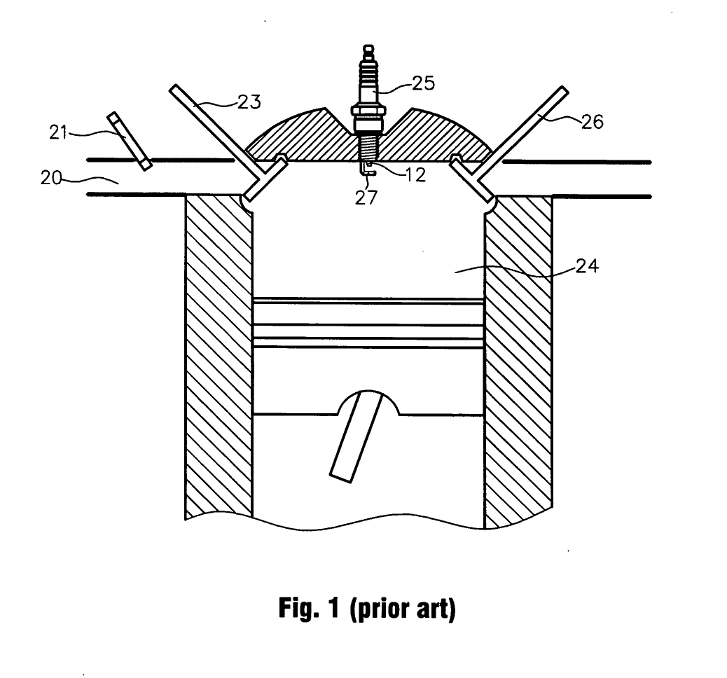

FIG. 2 is an assembly view of a spark plug in accordance with the present invention;

FIG. 3 is an operational view for showing the operation of a four-stroke cylinder in accordance with the present invention;

FIG. 4 is a side view of a part of the spark plug in accordance with a first embodiment of the present invention;

FIG. 5 is a side view of a part of the spark plug in accordance with a second embodiment of the present invention; and

FIG. 6 is a side view of a part of the spark plug in accordance with a third embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiments in accordance with the present invention.

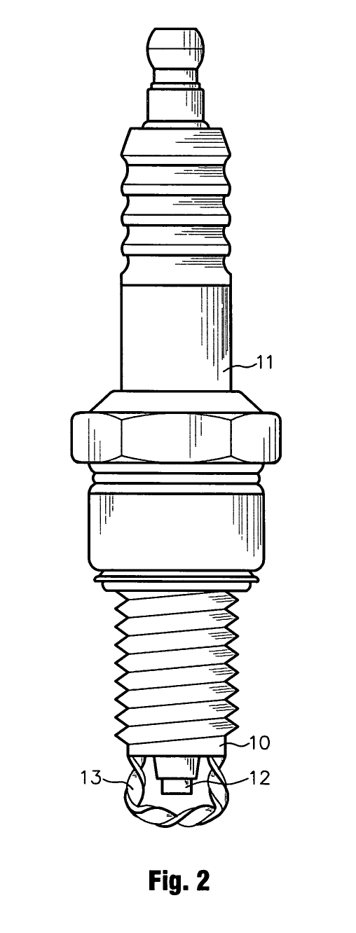

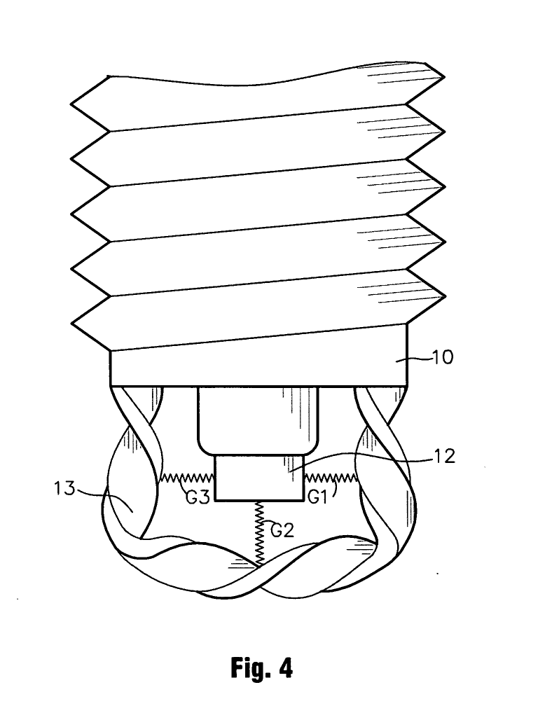

Referring to FIGS. 2-6, a spark plug for an internal combustion engine capable of improving the mixing degree between fuel and air in accordance with the present invention comprises: an isolator body 11, a metal casing 10, a central electrode 12, and a ground electrode 13. The first embodiment is shown in FIG. 4. A ground electrodes 13 is of three 180° spiral shape, both ends of the ground electrode 13 straddle the central electrode 12 and are connected to the metal casing 10. There are three spark gaps in the spark plug, a first spark gap G3 is formed between the central electrode 12 and a left spiral of the ground electrode 13, a second spark gap G1 is formed between the central electrode 12 and a right spiral of the ground electrode 13, and a third spark gap G2 is formed between the central electrode 12 and a central spiral of the ground electrode 13 opposite to the central electrode 12.

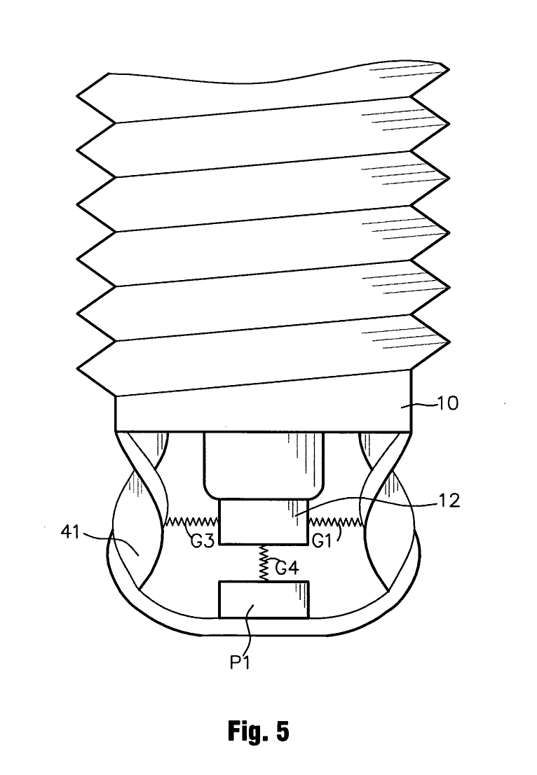

FIG. 5 shows a second embodiment of the spark plug capable of improving the mixing degree between fuel and air in accordance with the present invention. A ground electrodes 41 is of two 180° spiral shape, both ends of the ground electrode 41 straddle the central electrode 12 and are connected to the metal casing 10. There are three spark gaps in the spark plug, a first spark gap G3 is formed between the central electrode 12 and a left spiral of the ground electrode 41, a second spark gap G1 is formed between the central electrode 12 and a right spiral of the ground electrode 41, and a third spark gap G4 is formed between the central electrode 12 and a precious metal protrusion P1 on the ground electrode 41 opposite to the central electrode 12.

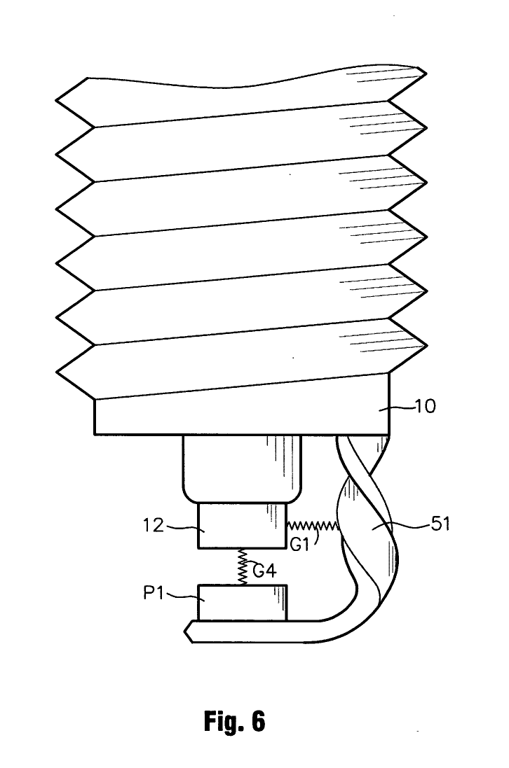

FIG. 6 shows a third embodiment of the spark plug capable of improving the mixing degree between fuel and air in accordance with the present invention. A ground electrodes 51 is of one 180° spiral shape, one end of the ground electrode 51 is connected to the metal casing 10, and the other end of the ground electrode 51 is formed with a precious metal protrusion P1 opposite to the central electrode 12. There are two spark gaps in the spark plug, a first spark gap G1 is formed between the central electrode 12 and a right spiral of the ground electrode 51, a second spark gap G4 is formed between the central electrode 12 and the precious metal protrusion P1.

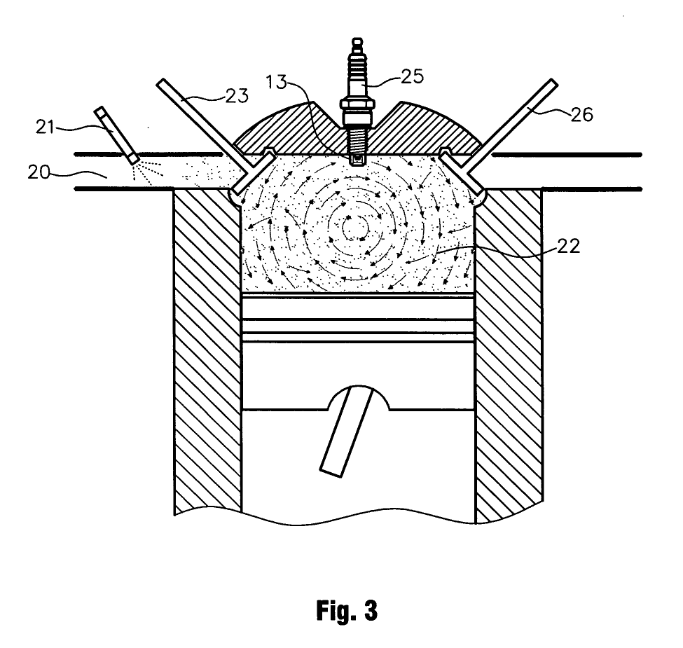

FIG. 3 is an operational view for showing the operation of a four-stroke cylinder in accordance with the present invention, wherein the spark plug creates an eddy in the combustion chamber, enabling the fuel and air to be mixed more uniformly. When the fuel sprayed into the intake manifold 20 by the fuel injector 21 and the fresh air inputted from the intake valve 23 are in contact with the spiral ground electrode 13, the mixture of the fuel and air will form an eddy status 22, thus improving the mixing degree between fuel and air.

When high voltage passes through the spark gaps between the central electrode 12 and the spiral ground electrode 13, a point discharge spark will be produced respectively, and the point discharges cause surface spark between the central electrode 12 and the respective spiral of the ground electrode 13, namely, sparks will be produced simultaneously in the three spark gaps, and the sparks will result in an eddy-shaped flame and will propagate swiftly throughout the entire combustion chamber. In this way, every corner of the combustion chamber can be swiftly and smoothly ignited, thus improving the combustion efficiency. Meanwhile, the previous carbon deposit can be smoothly discharged out of the combustion chamber, reducing fuel consumption and air pollution.

While we have shown and described various embodiments in accordance with the present invention, it is clear to those skilled in the art that further embodiments may be made without departing from the scope of the present invention.

What is claimed is:

1. A spark plug for improving the mixing degree between fuel and air, comprising an isolator body, a metal casing, a central electrode and a ground electrode; wherein the ground electrode is of three spiral shape, both ends of the ground electrode straddle the central electrode and are connected to the metal casing; a first spark gap is formed between the central electrode and a left spiral of the ground electrode, a second spark gap is formed between the central electrode and a right spiral of the ground electrode, and a third spark gap is formed between the central electrode and a central spiral of the ground electrode opposite to the central electrode.

2. A spark plug for improving the mixing degree between fuel and air, comprising an isolator body, a metal casing, a central electrode and a ground electrode; wherein the ground electrode is of two spiral shape, both ends of the ground electrode straddle the central electrode and are connected to the metal casing; a first spark gap is formed between the central electrode and a left spiral of the ground electrode, a second spark gap is formed between the central electrode and a right spiral of the ground electrode, and a third spark gap is formed between the central electrode and a precious metal protrusion on the ground electrode opposite to the central electrode.

3. A spark plug for improving the mixing degree between fuel and air, comprising an isolator body, a metal casing, a central electrode and a ground electrode; wherein the ground electrode is of one spiral shape, one end of the ground electrode is connected to the metal casing, and the other end of the ground electrode is formed with a precious metal protrusion opposite to the central electrode; a first spark gap is formed between the central electrode and a right spiral of the ground electrode, a second spark gap is formed between the central electrode and a precious metal protrusion on the other end of ground electrode opposite to the central electrode.

4. A spark plug for improving the mixing degree between fuel and air according to claim 1, wherein the ground electrode is of three 180° spiral shape.

5. A spark plug for improving the mixing degree between fuel and air according to claim 2, wherein the ground electrode is of two 180° spiral shape.

6. A spark plug for improving the mixing degree between fuel and air according to claim 3, wherein the ground electrode is of one 180° spiral shape.
